(19) United States
(12) Patent Application Publication
(10) Pub. No.: US 2023/0296409 A1
(43) Pub. Date: Sep. 21, 2023

(54) SIGNAL PROCESSING DEVICE, SIGNAL PROCESSING METHOD, AND NON-TRANSITORY COMPUTER-READABLE STORAGE MEDIUM

(71) Applicant: NEC Corporation, Minato-ku, Tokyo (JP)

(72) Inventors: Sakiko MISHIMA, Tokyo (JP); Reishi KONDO, Tokyo (JP)

(73) Assignee: NEC Corporation, Minato-ku, Tokyo (JP)

(21) Appl. No.: 18/021,245

(22) PCT Filed: Sep. 29, 2020
(86) PCT No.: PCT/JP2020/036778

§ 371 Date: Feb. 14, 2023

(51) Int. Cl. G01D 1/18

(52) U.S. Cl. CPC G01D 1/18

(57) ABSTRACT

A signal processing device according to an aspect of the present disclosure comprises: cutout means that cuts out a target signal in a predetermined section, and an overlap signal in a section not matching the predetermined section but overlapping with at least part of the predetermined section from an input signal; conversion means that converts the target signal and the overlap signal into a phase component signal in a frequency domain with respect to each frequency; gradient calculation means that, based on the phase component signal, calculates, at each frequency, a phase gradient that is the gradient of the phase component at the frequency; score calculation means that calculates a score relating to the sudden change characteristic of the input signal according to the phase gradients; and determination means that, based on the score, determines the presence or absence of a sudden change in the target signal.

### TECHNICAL FIELD

The present disclosure relates to a technique for detecting a change in a signal.

### BACKGROUND ART

There is a technology for detecting a change in a signal with respect to a time-series signal in which a plurality of types of signals is mixed. In particular, techniques related to detection of a sudden change signal which is a signal that suddenly changes are disclosed in PTL 1 and PTL 2.

PTL 1 discloses a technique of calculating a first gradient of a phase component signal for each frequency from an input signal, calculating a second gradient that is an average value of the calculated first gradients, and detecting presence or absence of a sudden change in the input signal based on a difference between the first gradient and the second gradient.

PTL 2 discloses a technique of weighting a first gradient based on amplitude, calculating an average of the weighted first gradients as a second gradient, and detecting presence or absence of a sudden change in an input signal based on a difference between the second gradient and the first gradient.

### CITATION LIST

### Patent Literature

[PTL 1] JP 6406258 B2

[PTL 2] JP 6406257 B2

### SUMMARY OF INVENTION

### Technical Problem

Here, the detection of the presence or absence of a sudden change in the signal indicates detection of whether a sudden change signal is included in the signal. In the input signal, in a case where a ratio of a signal (non-sudden change signal) that is not a sudden change signal is large with respect to the sudden change signal, that is, in a case where a ratio of the sudden change signal to the non-sudden change signal is small, a ratio of a frequency at which a gradient of the phase component signal caused by the sudden change signal is obtained decreases.

In the techniques described in PTLs 1 and 2, the first gradient and the second gradient are calculated only from the signal in the section in which the presence or absence of the sudden change is desired to be detected, and the difference between the first gradient and the second gradient for each frequency is simply calculated. Therefore, as described above, in a case where the ratio of the frequency at which the gradient of the phase component signal caused by the sudden change signal is obtained decreases, the accuracy of detecting the presence or absence of the sudden change deteriorates.

The present disclosure has been made in view of the above problems, and an object of the present disclosure is to provide a signal processing device and the like capable of accurately detecting a sudden change in a signal.

### Solution to Problem

A signal processing device according to an aspect of the present disclosure includes: a cutout means configured to cut out, from an input signal, a determination target signal in a predetermined section, and an overlap signal in a section not matching the predetermined section but overlapping with at least a part of the predetermined section; a conversion means configured to convert each of the determination target signal and the overlap signal into a phase component signal in a frequency domain with respect to each frequency; a gradient calculation means configured to calculate, based on the phase component signal, at each frequency, a phase gradient being the gradient of the phase component at the frequency; a score calculation means configured to calculate a score relating to the sudden change characteristic of the input signal according to the plurality of phase gradients; and a determination means configured to determine, based on the score, the presence or absence of a sudden change in the determination target signal.

A signal processing method according to an aspect of the present disclosure includes: cutting out, from an input signal, a determination target signal in a predetermined section, and an overlap signal in a section not matching the predetermined section but overlapping with at least a part of the predetermined section; converting each of the determination target signal and the overlap signal into a phase component signal in a frequency domain with respect to each frequency; calculating, based on the phase component signal, at each frequency, a phase gradient being a gradient of a phase component at a frequency; calculating a score relating to a sudden change characteristic of the input signal according to a plurality of phase gradients; and determining, based on the score, presence or absence of a sudden change in the determination target signal.

A computer-readable storage medium according to an aspect of the present disclosure stores a program causing a computer to execute: cutting out, from an input signal, a determination target signal in a predetermined section, and an overlap signal in a section not matching the predetermined section but overlapping with at least a part of the predetermined section; converting each of the determination target signal and the overlap signal into a phase component signal in a frequency domain with respect to each frequency; calculating, based on the phase component signal, at each frequency, a phase gradient being a gradient of a phase component at a frequency; calculating a score relating to a sudden change characteristic of the input signal according to a plurality of phase gradients; and determining, based on the score, presence or absence of a sudden change in the determination target signal.

### Advantageous Effects of Invention

According to the present disclosure, it is possible to accurately detect a sudden change in a signal.

### BRIEF DESCRIPTION OF DRAWINGS

FIG. 1 is a block diagram illustrating an example of a functional configuration of a signal processing device according to a first example embodiment of the present disclosure.

FIG. 2 is a diagram illustrating an example of how to cut out a signal according to the first example embodiment of the present disclosure.

FIG. 3 is a diagram illustrating an example of an image of a local score according to the first example embodiment of the present disclosure.

FIG. 4 is a diagram illustrating an example of an image for calculating a score according to the first example embodiment of the present disclosure.

FIG. 5 is a flowchart illustrating an example of an operation of a signal processing device according to the first example embodiment of the present disclosure.

FIG. 6 is a block diagram illustrating an example of a functional configuration of a signal processing device according to a second example embodiment of the present disclosure.

FIG. 7 is a flowchart illustrating an example of an operation of the signal processing device according to the second example embodiment of the present disclosure.

FIG. 8 is a block diagram illustrating an example of a hardware configuration of a computer device that implements the signal processing devices according to the first and second example embodiments of the present disclosure.

### EXAMPLE EMBODIMENT

Hereinafter, example embodiments of the present disclosure will be described with reference to the drawings.

### First Example Embodiment

A signal processing device according to a first example embodiment will be described.

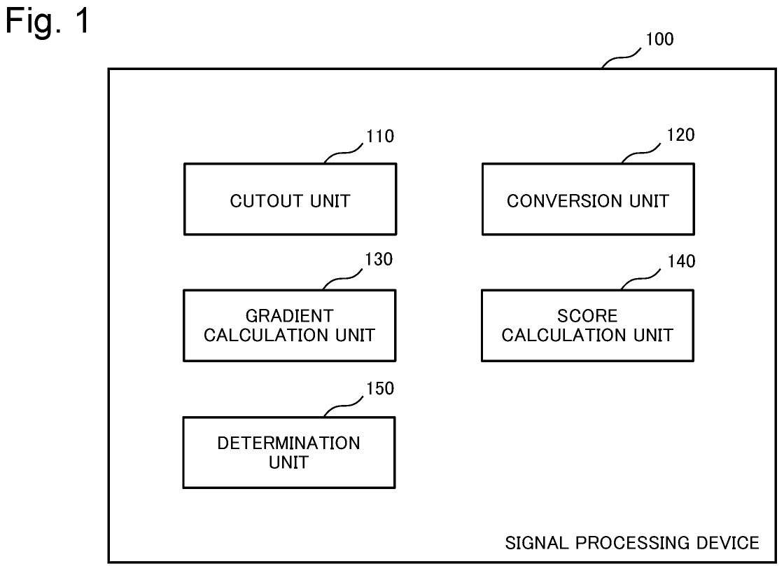

FIG. 1 is a block diagram illustrating an example of a functional configuration of a signal processing device 100 according to the first example embodiment. As illustrated in FIG. 1, the signal processing device 100 includes a cutout unit 110, a conversion unit 120, a gradient calculation unit 130, a score calculation unit 140, and a determination unit 150.

The cutout unit 110 cuts out, from the input signal, a determination target signal in a predetermined section and an overlap signal in a section that does not match the predetermined section and overlaps at least a part of the predetermined section. The input signal is, for example, a time-series signal input to the signal processing device 100, and includes a plurality of types of signals. The cutout unit 110 cuts out a determination target signal that is a signal in a predetermined section for determining whether a sudden change signal is included in the input signal. The cutout unit 110 cuts out, from the input signal, an overlap signal that is a signal in a section that does not match the section of the determination target signal and overlaps at least a part of the section of the determination target signal. At this time, for example, the cutout unit 110 may calculate the leading clock time of the determination target signal and the time difference between the leading clock time of the determination target signal and the leading clock time of the overlap signal. The cutout unit 110 is an example of a cutout means.

The conversion unit 120 converts each of the determination target signal and the overlap signal into a phase component signal in the frequency domain for each frequency. The conversion unit 120 is an example of a conversion means.

Based on the phase component signal, the gradient calculation unit 130 calculates a phase gradient being a gradient of the phase component in the frequency at each frequency. For example, the gradient calculation unit 130 calculates a phase gradient for each frequency from the phase component signal. For example, the gradient calculation unit 130 may calculate the phase gradient by obtaining a phase difference at adjacent frequencies or may calculate the phase gradient by another method. The gradient calculation unit 130 is an example of a calculation means.

The score calculation unit 140 calculates a score relating to the sudden change characteristic of the input signal according to the plurality of phase gradients. For example, the score calculation unit 140 calculates a value relating to the appearance frequency of the phase gradient for each of the signals cut out by the cutout unit 110. Then, for example, the score calculation unit 140 calculates the score by integrating the values relating to the appearance frequency of the phase gradient calculated for each cut out signal. More specifically, for example, the score calculation unit 140 sets a result obtained by adding a value relevant to the same time among the calculated values relating to the appearance frequency of the phase gradient as a score. In this way, by integrating the values relevant to the same time among the values relating to the appearance frequency of the phase gradient, the value relating to the appearance frequency of the phase gradient in the section in which the section of the determination target signal and the section of the overlap signal overlap is emphasized. The score calculation unit 140 may perform weighting according to the appearance frequency on the calculated value relating to the appearance frequency, and may set a result obtained by adding a value relevant to the same time among the weighted values relating to the appearance frequency as a score. The score calculation unit 140 is an example of a score calculation means.

The determination unit 150 determines the presence or absence of a sudden change in the determination target signal based on the score. For example, the determination unit 150 determines whether the determination target signal includes a sudden change signal based on the maximum value of the score and the time at which the score becomes maximum. At this time, for example, when the maximum value of the score is equal to or greater than a predetermined threshold and the time at which the score becomes maximum is included in the section of the determination target signal, the determination unit 150 determines that the determination target signal includes a sudden change signal, that is, the determination target signal has a sudden change. The determination unit 150 is an example of a determination means.

As described above, the signal processing device 100 according to the first example embodiment calculates the score relating to the sudden change characteristic of the input signal using the overlap signal in the section overlapping the section of the determination target signal. The score at this time is calculated by integrating values relevant to the same time among the values relating to the appearance frequency of the phase gradient calculated for each section. Then, the signal processing device 100 determines the presence or absence of a sudden change in the determination target signal based on the score. As a result, since the score is calculated after the information relating to the gradient of the phase component signal caused by the sudden change signal is emphasized, the signal processing device 100 according to the first example embodiment can detect the sudden change in the signal with high accuracy.

[Details of Signal Processing Device 100]

Next, an example of each configuration of the signal processing device 100 of the first example embodiment will be described more specifically.

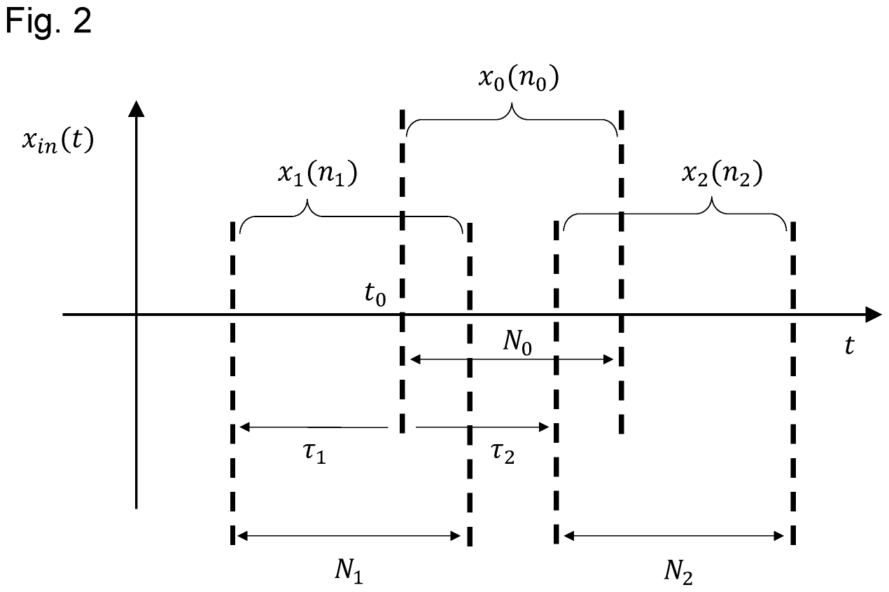

The cutout unit 110 acquires an input signal input to the signal processing device 100. The cutout unit 110 cuts out a plurality of signals from the acquired input signal. FIG. 2 is a diagram illustrating an example of how to cut out a signal. In FIG. 2, xᵢₙ(t) represents an input signal, and t represents time. In FIG. 2, the waveform of the input signal is omitted in order to enhance the visibility of the drawing.

The cutout unit 110 cuts out the determination target signal x₀(n₀) from the input signal xᵢₙ(t). At this time, x₀(n₀) is a signal in a section from time to until N₀ (>0) time elapses. Further, the cutout unit 110 cuts out an overlap signal that is a signal overlapping at least a part of the determination target signal x₀(n₀). FIG. 2 illustrates an example of overlap signals x₁(n₁) and x₂(n₂) partially overlapping the determination target signal x₀(n₀). x₁(n₁) is a signal in a section from time shifted by τ₁ (<0) time from time t₀ to N₁ (>0) time with respect to the input signal. x₂(n₂) is a signal in a section from time shifted by τ₂ (>0) time from time t₀ to N₂ (>0) time with respect to the input signal. In the present disclosure, a signal cut out by the cutout unit 110 is expressed as x_{d}(n_{d}) (0≤d≤D). The length of time in each section of the cut out signal (the determination target signal and the overlap signal) is represented as N_{d}, and a value obtained by subtracting t₀ from the leading clock time of the cut out signal, that is, the time difference between the cut out signal and the determination target signal at the leading clock time is represented as τ_{d}. At this time, τ₀=0. Time n_{d} in the cut-out section is expressed as (0≤n_{d}<N_{d}). FIG. 2 illustrates an example in which a part of the overlap signal overlaps the determination target signal, but the overlap signal is not limited to this example. The overlap signal may not match the determination target signal. For example, the overlap signal may be included in the determination target signal or may include the determination target signal. In the present disclosure, a section of a signal cut out by the cutout unit 110 is also referred to as a frame. Although two overlap signals are cut out in FIG. 2, the number of overlap signals is not limited to this example. The number of overlap signals may be one or more. As compared with a case where the number of overlap signals is one, in a case where a plurality of overlap signals is cut out, the signal processing device 100 according to the first example embodiment can detect the presence or absence of a sudden change in a signal with higher accuracy since the information relating to the gradient of the phase component signal caused by the sudden change signal is more emphasized.

The cutout unit 110 cuts out a signal from the input signal by using, for example, a predetermined window function. The cutout unit 110 can cut out a signal using, for example, a rectangular window. Not limited to this example, the cutout unit 110 may use another window function such as a Gaussian window, a Hanning window, or a Hamming window.

The conversion unit 120 acquires the signal cut out by the cutout unit 110. The conversion unit 120 converts the acquired signal, that is, each of the determination target signal and the overlap signal into a phase component signal for each frequency. The conversion unit 120 calculates the phase component signal X_{d}(k) using, for example, the discrete Fourier transform expressed in Expression 1.

$${X}_{d} ( k ) = {\sum }_{{n}_{d} = 0}^{{N}_{d}} {x}_{d} ( {n}_{d} ) {e}^{- j \frac{2 π {kn}_{d}}{{N}_{d}}} \qquad [ Math . 1 ]$$

In Expression 1, k (0≤k<K−1: K is a natural number) is an index indicating a frequency. Each of the values of k is relevant to each of the frequencies included in the signal. The conversion unit 120 may calculate the phase component signal by another transform method such as Fourier transform or wavelet transform instead of the discrete Fourier transform.

The gradient calculation unit 130 calculates the gradient of the phase component based on the phase component signal. The gradient of the phase component indicates the degree of change in phase at adjacent frequencies. In the present disclosure, the gradient of the phase component is also referred to as a phase gradient. The gradient calculation unit 130 may use an unwrapped phase when obtaining the phase gradient Δθ_{d}(k) from the phase component signal X_{d}(k). The following Expressions 2, 3, and 4 are examples of calculating the phase gradient using the unwrapped phase.

$${θ}_{d} ( k ) = {tan}^{- 1} \frac{Im \{ {X}_{d} ( k ) \}}{Re \{ {X}_{d} ( k ) \}} \qquad [ Math . 2 ]$$

Expression 2 is an expression for obtaining the phase θ_{d}(k) for each frequency for each frame. For example, when the phase component signal is expressed by a complex number as in Expression 2, the phase is obtained by applying an inverse function of tangent (tan) to a vector indicating the phase component signal.

$${{θ}^{'}}_{d} ( k ) = \{ \begin{matrix}{θ}_{d} ( k ) - 2 π & if {θ}_{d} ( k ) - {θ}_{d} ( k - 1 ) > π \\ {θ}_{d} ( k ) + 2 π & else if {θ}_{d} ( k ) - {θ}_{d} ( k - 1 ) < - π \\ {θ}_{d} ( k ) & otherwise\end{matrix} \qquad [ Math . 3 ]$$

Expression 3 is an expression for calculating the unwrapped phase. The unwrapped phase is an absolute phase whose phase range is not limited to −πto π. The unwrapped phase is obtained according to a phase difference between adjacent frequencies.

Δθ_{d}(k)=\acute{θ}_{d}(k)−\acute{θ}_{d}(k−1) [Math. 4]

As represented in Expression 4, the gradient calculation unit 130 calculates a phase gradient at each frequency based on a difference between unwrapped phases at adjacent frequencies.

The gradient calculation unit 130 may calculate the phase gradient using the following Expression 5, Expression 6, and Expression 7.

$${\hat{X}}_{d} ( k ) = \frac{{X}_{d} ( k )}{\vert {X}_{d} ( k ) \vert} = {e}^{j {θ}_{d} ( k )} \qquad [ Math . 5 ]$$

$${{X}^{'}}_{d} ( k ) = {\hat{X}}_{d} ( k ) \cdot {\hat{X}}_{d} ( k - 1 ) = {e}^{j \{ {θ}_{d} ( k ) - {θ}_{d} ( k - 1 ) \}} \qquad \text{[Math. 6]}$$

$$Δ {θ}_{d} ( k ) = {tan}^{- 1} \frac{Im \{ {{X}^{'}}_{d} ( k ) \}}{Re \{ {{X}^{'}}_{d} ( k ) \}} \qquad [ Math . 7 ]$$

For example, the gradient calculation unit 130 normalizes the phase component signal at each frequency to a unit vector using Expression 5. Then, as represented in Expression 6, the gradient calculation unit 130 calculates an inner product of unit vectors at adjacent frequencies. As a result, a vector obtained by combining unit vectors at adjacent frequencies on the complex plane is calculated. At this time, the phase of the calculated vector corresponds to the phase gradient with respect to the frequency k. Therefore, the gradient calculation unit 130 can calculate the phase gradient by obtaining the phase of the vector calculated in Expression 6 as in Expression 7.

Next, the score calculation unit 140 calculates a score relating to the sudden change characteristic of the input signal according to the phase gradient acquired from the gradient calculation unit 130. Specifically, the score calculation unit 140 calculates the score y(t) relating to the sudden change characteristic of the input signal using the following Expressions 8 and 9.

$${S}_{d} ( {n}_{d} ) = {\sum }_{k = 0}^{K - 1} u ( {n}_{d} , k ) \qquad [ Math . 8 ]$$

$$u ( {n}_{d} , k ) = \{ \begin{matrix}1 & if {n}_{d} = Δ {θ}_{d} ( k ) \frac{{N}_{d}}{2 π} \\ 0 & otherwise\end{matrix}$$

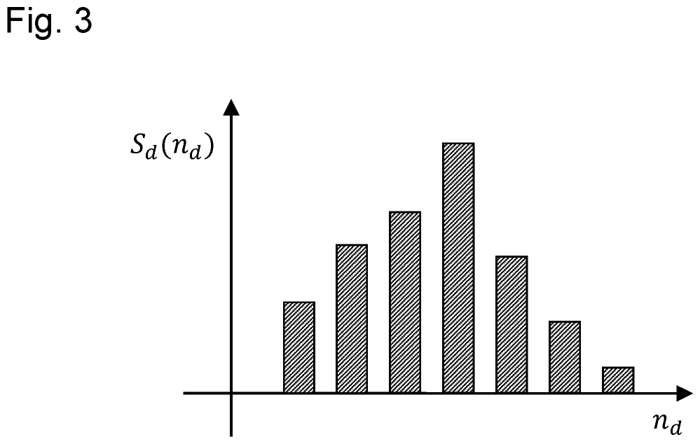

Expression 8 is an expression for calculating the local score S_{d}(n_{d}) indicating the appearance frequency of the phase gradient for each time of a certain frame. FIG. 3 is a diagram illustrating an image of the local score S_{d}(n_{d}) in a certain frame. The larger the number of S_{d}(n_{d}), the higher the frequency having the same phase gradient at the in-frame time, that is, the appearance frequency of the phase gradient at the time of the frame. As illustrated in FIG. 3, the score calculation unit 140 aggregates the local scores for each frame.

Next, the score calculation unit 140 calculates a score y(t) relating to the sudden change characteristic of the input signal using Expression 9. In the present specification, the score relating to the sudden change characteristic of the input signal is also simply referred to as “score”.

$$y ( t ) = {\sum }_{d = 0}^{D - 1} {S}_{d} ( {n}_{d} ) = {\sum }_{d = 0}^{D - 1} {S}_{d} ( t - ( {t}_{0} + {τ}_{d} ) ) \qquad [ Math . 9 ]$$

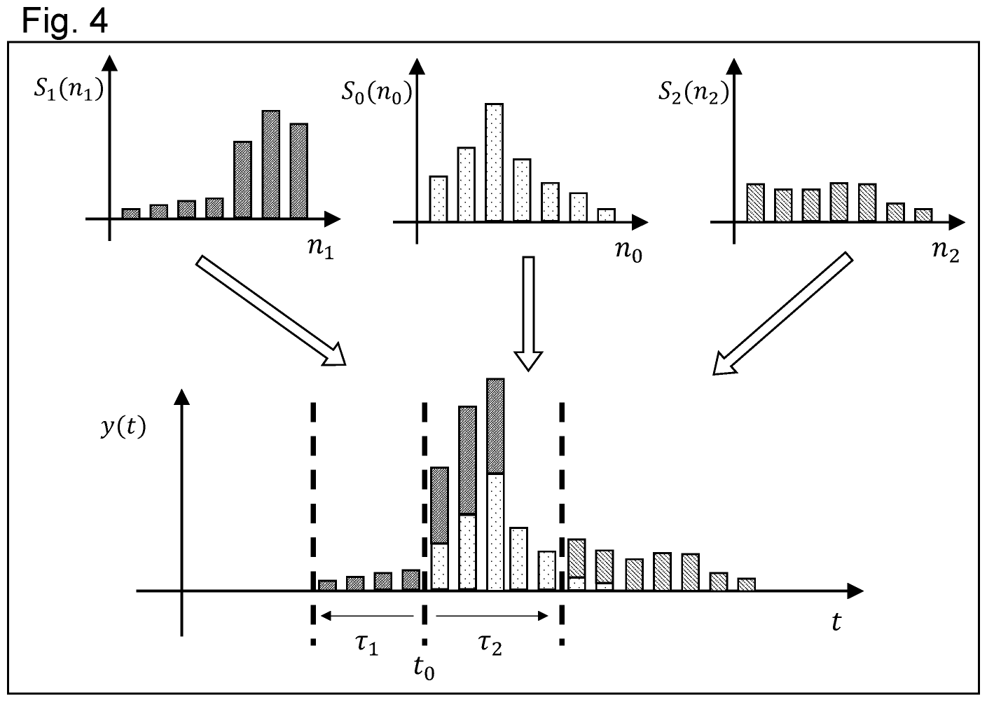

Expression 9 is an expression for calculating the score y(t). The score y(t) is obtained by converting each of the local scores S_{d}(n_{d}) into a time axis of t and integrating the local scores at the same time on the time axis of t. FIG. 4 is a diagram illustrating an image for calculating a score. FIG. 4 illustrates an example of the score in a case where the determination target signal x₀(n₀) and the overlap signals x₁(n₁) and x₂(n₂) are cut out. In FIG. 4, local scores S₀(n₀), S₁(n₁), and S₂(n₂) are calculated for each signal. Then, the score calculation unit 140 integrates the local scores by adding values relevant to the same time among the local scores.

In this manner, the score calculation unit 140 calculates the value (for example, the local score S_{d}(n_{d})) relating to the appearance frequency of the phase gradient in each of the determination target signal and the overlap signal, and calculates the score by integrating the values relevant to the same time among the calculated values relating to the appearance frequency.

The determination unit 150 determines whether the determination target signal includes a sudden change signal based on the score calculated by the score calculation unit 140.

$$p = \{ \begin{matrix}1 & α \leq max y ( t ) and {t}_{0} \leq arg max y ( t ) < {t}_{0} + {N}_{0} \\ 0 & otherwise\end{matrix} \qquad [ Math . 10 ]$$

Expression 10 is an expression indicating a determination method. Expression 10 indicates that the determination unit 150 determines that the determination target signal includes the sudden change signal when p=1, and indicates that the determination unit 150 determines that the determination target signal does not include the sudden change signal when p=0. In a case where the maximum value of the score is equal to or greater than a threshold α and the time when the score is the maximum is the time between the frames of the determination target signal, the determination unit 150 determines that the determination target signal includes the sudden change signal, using Expression 10.

In this manner, the determination unit 150 determines the presence or absence of a sudden change in the determination target signal based on the maximum value of the score and the time at which the score becomes maximum.

(Operation of Signal Processing Device 100)

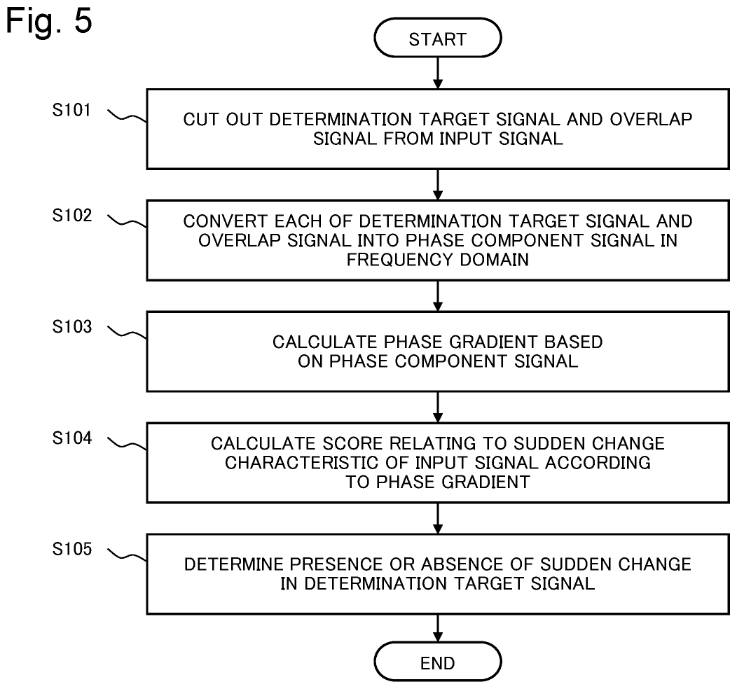

Next, the operation of the signal processing device 100 will be described with reference to FIG. 5. FIG. 5 is a flowchart for explaining the operation of the signal processing device 100. In the operation described below, it is assumed that an input signal is input to the signal processing device 100. In the present specification, each step of the flowchart is expressed using a number assigned to each step, such as “S101”.

The cutout unit 110 cuts out the determination target signal and the overlap signal from the input signal (S101). The conversion unit 120 converts each of the determination target signal and the overlap signal into a phase component signal in the frequency domain (S102). Next, the gradient calculation unit 130 calculates a phase gradient based on the phase component signal (S103). Then, the score calculation unit 140 calculates a score relating to the sudden change characteristic of the input signal according to the calculated phase gradient (S104). The determination unit 150 determines the presence or absence of a sudden change in the determination target signal based on the calculated score (S105).

As described above, the signal processing device 100 according to the first example embodiment cuts out, from the input signal, the determination target signal in the predetermined section and the overlap signal in the section that does not match the predetermined section and overlaps at least a part of the predetermined section. The signal processing device 100 converts each of the determination target signal and the overlap signal into a phase component signal in a frequency domain for each frequency, and calculates a phase gradient that is a gradient of a phase component at the frequency for each frequency based on the phase component signal. Then, the signal processing device 100 calculates a score relating to the sudden change characteristic of the input signal according to the plurality of phase gradients, and determines the presence or absence of the sudden change in the determination target signal based on the score. As described above, since the signal processing device 100 according to the first example embodiment calculates the score according to the phase gradient obtained from each of the determination target signal and the overlap signal partially overlapping the section of the determination target signal, it is possible to calculate the score in which the information on the gradient of the phase component signal caused by the sudden change signal is emphasized even when a ratio of the sudden change signal to non-sudden change signal is small in the input signal. Therefore, the signal processing device 100 according to the first example embodiment can accurately detect a sudden change in a signal.

[Modification 1]

The score calculation unit 140 may perform weighting according to the appearance frequency on the value S_{d}(n_{d}) relating to the appearance frequency of the phase gradient. Specifically, the score calculation unit 140 may perform weighting using w_{d} as in Expression 11.

y(t)=Σ_{d=0}^{D-1}w_{d}·S_{d}(n_{d}+τ_{d}) [Math. 11]

w_{d} is obtained, for example, based on the variance in S_{d}(n_{d}). As the variance is larger with respect to S_{d}(n_{d}), there is a higher possibility that the sudden change signal is included at the time n of the frame. Therefore, the score calculation unit 140 may calculate w_{d} using Expression 12.

$${w}_{d} = \frac{2}{{N}_{d}} {\sum }_{{n}_{d} = 0}^{{N}_{d} / 2} ( {S}_{d} ( {n}_{d} ) - {S}_{ave} ) \qquad [ Math . 12 ]$$

Sₐᵥₑ in Expression 12 is an average of S_{d}(n_{d}). At this time, the larger the variance with respect to S_{d}(n_{d}), the larger the value of w_{d}.

w_{d} may be obtained based on the variance with respect to n_{d}. As the variance is smaller than n_{d}, the value of S_{d}(n_{d}) is calculated to be biased in a part of time. That is, there is a high possibility that a sudden change signal is included at that time. Therefore, the score calculation unit 140 may calculate w_{d} using Expression 13.

$${w}_{d} = 1 / ( \frac{2}{{N}_{d}} {\sum }_{{n}_{d} = 0}^{{N}_{d} / 2} ( {n}_{d} - {n}_{ave} ) ) \qquad [ Math . 13 ]$$

nₐᵥₑ in Expression 13 is an average of n_{d}. At this time, the smaller the variance with respect to n_{d}, the larger the value of w_{d}.

As described above, the signal processing device 100 may calculate the score by weighting the value relating to the appearance frequency of the phase gradient according to the appearance frequency and integrating the values relevant to the same time among the weighted values relating to the appearance frequency. With this configuration, the signal processing device 100 of Modification 1 can emphasize the value relating to the appearance frequency at the time at which there is a high possibility that the sudden change signal is included, so that the presence or absence of the sudden change in the signal can be detected more accurately.

[Modification 2]

The determination unit 150 may determine whether the determination target signal includes a sudden change signal by using the estimated distribution value of the score. Specifically, a probability density function according to a normal distribution is fitted to the score y(t), and it is determined whether the determination target signal includes a sudden change signal based on a parameter of the probability density function at that time.

$$g ( t ) = \frac{1}{\sqrt{2 {πσ}^{2}}} exp ( - \frac{{( t - μ )}^{2}}{2 {σ}^{2}} ) \qquad [ Math . 14 ]$$

$$f ( μ , σ ) = g ( t ) - y ( t ) \qquad [ Math . 15 ]$$

Expression 14 is an expression indicating a probability density function g(t) according to the normal distribution. Expression 15 is an expression of a function indicating a difference between the score y(t) and the probability density function g(t). The determination unit 150 fits the probability density function g(t) to the score y(t) expressed in Expression 9 or Expression 11. That is, the determination unit 150 calculates the values of an average μ and a standard deviation σ when a function f(μ, σ) is minimized. Then, the determination unit 150 uses the calculated μ and σ to make a determination based on Expression 16 below.

$$p = \{ \begin{matrix}1 & α \leq \frac{1}{σ} g ( μ ) and {t}_{0} \leq μ < {t}_{0} + {N}_{0} \\ 0 & otherwise\end{matrix} \qquad [ Math . 16 ]$$

For example, when the value of g(μ)×1/σ is equal to or greater than the threshold α and the value of μ is a value between frames of the discrimination target signal, the determination unit 150 determines that the discrimination target signal includes a sudden change signal.

Here, g(μ) is a value relevant to the maximum value of the score y(t). With respect to g(t), the larger the value of σ, the larger the variance at g(t). That is, as the value of σ increases, g(t) is a function that performs a gradual change. In a case where g(t) changes gently, even if g(μ) exceeds the threshold α, the possibility that the sudden change signal is included in the determination target signal decreases. Therefore, the determination unit 150 converts the value to be compared with the threshold α according to the value of σ.

As described above, the signal processing device 100 of Modification 2 determines the presence or absence of a sudden change in the determination target signal based on the value obtained by converting the maximum value in the probability density function fitted to the score according to the variance of the probability density function and the time at which the value of the probability density function becomes maximum. With this configuration, the signal processing device 100 of Modification 2 can determine the presence or absence of the sudden change in the determination target signal with higher accuracy than when the maximum value of the score is used.

### Second Example Embodiment

Next, a signal processing device according to a second example embodiment will be described.

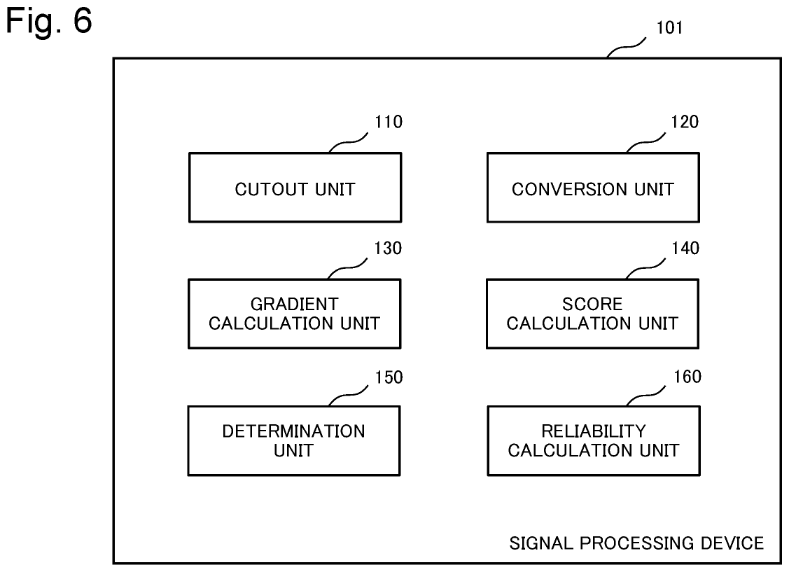

FIG. 6 is a block diagram illustrating an example of a functional configuration of a signal processing device 101 of the second example embodiment. As illustrated in FIG. 6, the signal processing device 101 includes a reliability calculation unit 160 in addition to the configuration of the signal processing device 100 of the first example embodiment. That is, the signal processing device 101 includes a cutout unit 110, a conversion unit 120, a gradient calculation unit 130, a score calculation unit 140, a determination unit 150, and a reliability calculation unit 160. The description of the configuration and operation of the signal processing device 101 illustrated in FIG. 6 overlapping with the description of the first example embodiment will be omitted.

[Details of Signal Processing Device 101]

When the determination unit 150 determines that there is a sudden change in the determination target signal, the reliability calculation unit 160 calculates, for each frequency of the determination target signal, the reliability indicating the possibility of being the frequency of the signal (that is, the sudden change signal) indicating the sudden change according to the score. For example, the reliability calculation unit 160 compares a value estimated as the phase gradient of the sudden change signal with the phase gradient of each frequency of the determination target signal. Then, the reliability calculation unit 160 calculates, as the reliability, a value indicating the possibility of being the frequency of the sudden change signal for each frequency of the determination target signal.

$$Δ \hat{θ} = - 2 π \frac{arg max y ( t )}{{N}_{0}} \qquad [ Math . 17 ]$$

Expression 17 is an expression for calculating an estimated value of the phase gradient of the sudden change signal. The reliability calculation unit 160 calculates an estimated value of the phase gradient of the sudden change signal using, for example, Expression 17. At this time, the reliability calculation unit 160 calculates the phase gradient of the input signal at the time when the score y(t) becomes the maximum value as the estimated value of the phase gradient of the sudden change signal.

Y(□)=|Δ□₀(□)−Δ\hat{□}| [Math. 18]

Then, the reliability calculation unit 160 calculates the reliability Y(k) by obtaining a difference between the estimated value of the phase gradient of the sudden change signal and the phase gradient of the determination target signal for each frequency of the determination target signal using Expression 18. At this time, the smaller the difference between the estimated value and the phase gradient of the determination target signal, the higher the possibility that the frequency having the phase gradient of the compared determination target signal is the frequency of the sudden change signal. On the other hand, the larger the difference between the estimated value and the phase gradient of the determination target signal, the higher the possibility that the frequency having the phase gradient of the compared determination target signal is not the frequency of the sudden change signal, that is, the higher the possibility that the frequency is the frequency of the signal that is not the sudden change signal.

As described above, when it is determined that there is a sudden change in the determination target signal, the reliability calculation unit 160 calculates, for each frequency of the determination target signal, the reliability indicating the possibility of being the frequency of the signal indicating the sudden change based on the phase gradient of each frequency of the determination target signal and the estimated value of the phase gradient of the signal indicating the sudden change calculated according to the score. The reliability calculation unit 160 is an example of a reliability calculation means.

[Operation of Signal Processing Device 101]

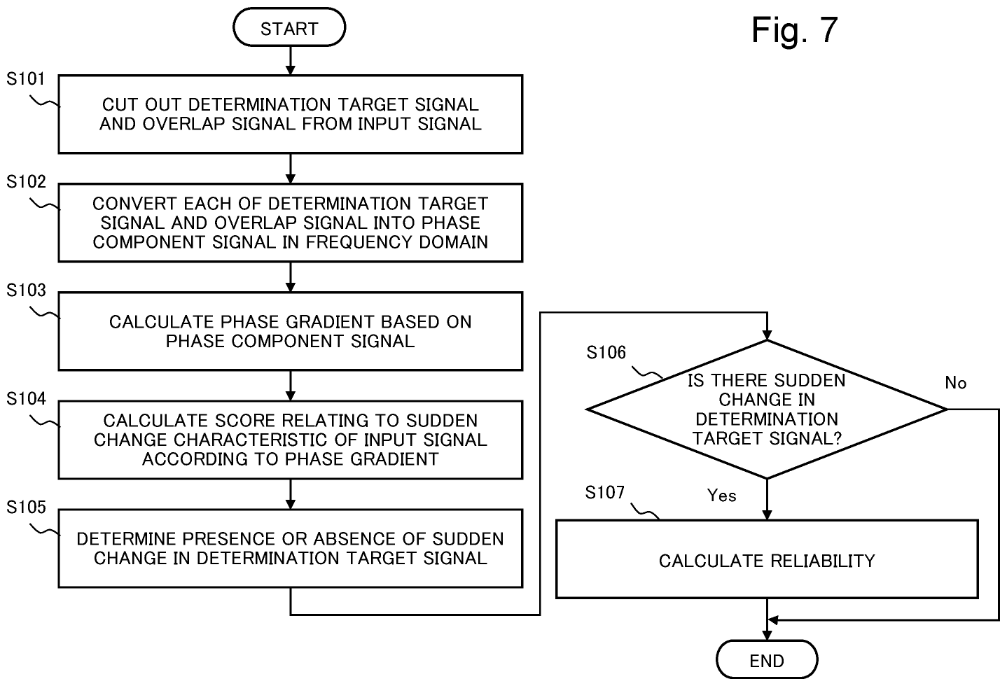

Next, the operation of the signal processing device 101 will be described with reference to FIG. 7. FIG. 7 is a flowchart illustrating an example of the operation of the signal processing device 101. In FIG. 7, since the processing of S101 to S105 is similar to the processing of S101 to S105 in FIG. 5, the description thereof will be omitted.

In the processing of S105, when it is determined that there is no sudden change in the determination target signal (“No” in S106), the signal processing device 101 ends the flow. When it is determined that there is a sudden change in the determination target signal (“Yes” in S106), the reliability calculation unit 160 calculates the reliability for each frequency of the determination target signal based on the estimated value of the phase gradient of the sudden change signal calculated according to the score and the phase gradient for each frequency of the determination target signal (S107).

As described above, when it is determined that there is a sudden change in the determination target signal, the signal processing device 101 according to the second example embodiment calculates, for each frequency of the determination target signal, the reliability indicating the possibility of being the frequency of the signal indicating the sudden change based on the phase gradient of each frequency of the determination target signal and the estimated value of the phase gradient of the signal indicating the sudden change calculated according to the score. With this configuration, the signal processing device 101 according to the second example embodiment can determine which frequency of the signal in the determination target signal is highly likely to be a signal of a frequency caused by a sudden change signal or a signal of a frequency caused by a signal that is not a sudden change signal. According to this determination result, for example, the user can remove the non-sudden change signal from the determination target signal or, conversely, can remove the sudden change signal from the determination target signal.

<Exemplary Hardware Configuration of Signal Processing Device>

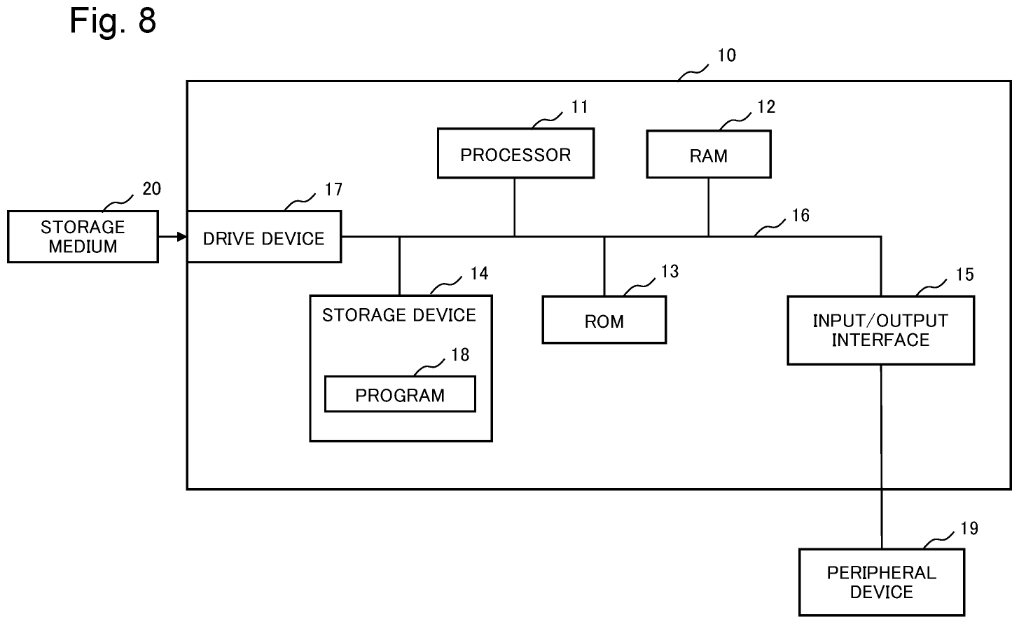

Hardware constituting the signal processing devices of the first and second example embodiments will be described. FIG. 8 is a block diagram illustrating an example of a hardware configuration of a computer device that implements the signal processing device according to each example embodiment. Each block illustrated in FIG. 8 can be implemented by a combination of a computer device 10 that implements the signal processing device and the signal processing method in each example embodiment and software.

As illustrated in FIG. 8, the computer device 10 includes a processor 11, a random access memory (RAM) 12, a read only memory (ROM) 13, a storage device 14, an input/output interface 15, a bus 16, and a drive device 17. The signal processing device may be implemented by a plurality of electric circuits.

The storage device 14 stores a program (computer program) 18. The processor 11 executes the program 18 of the signal processing device using the RAM 12. Specifically, for example, the program 18 includes a program that causes a computer to execute the processing of the signal processing device described in FIGS. 5 and 6. When the processor 11 executes the program 18, the functions of the components (the cutout unit 110, the conversion unit 120, the gradient calculation unit 130, the score calculation unit 140, the determination unit 150, and the reliability calculation unit 160 described above) of the signal processing device are implemented. The program 18 may be stored in the ROM 13. The program 18 may be recorded in the storage medium 20 and read using the drive device 17, or may be transmitted from an external device (not illustrated) to the computer device 10 via a network (not illustrated).

The input/output interface 15 exchanges data with a peripheral device (keyboard, mouse, display, etc.) 19. The input/output interface 15 functions as a means for acquiring or outputting data. The bus 16 connects the components

There are various modifications of the method of implementing the signal processing device. For example, the signal processing device can be implemented as a dedicated device. The signal processing device can be implemented based on a combination of a plurality of devices.

Processing methods for causing a storage medium to record a program for implementing components in a function of each example embodiment, reading the program recorded in the storage medium as a code, and executing the program in a computer are also included in the scope of each example embodiment. That is, a computer-readable storage medium is also included in the scope of each example embodiment. A storage medium in which the above-described program is recorded and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the storage medium is not limited to a program that executes processing alone, and programs that operate on an operating system (OS) to execute processing in cooperation with other software and functions of an extension board are also included in the scope of each example embodiment.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

<Supplementary Notes>

[Supplementary Note 1]

A signal processing device including:
a cutout means configured to cut out, from an input signal, a determination target signal in a predetermined section, and an overlap signal in a section not matching the predetermined section but overlapping with at least a part of the predetermined section;
a conversion means configured to convert each of the determination target signal and the overlap signal into a phase component signal in a frequency domain with respect to each frequency;
a gradient calculation means configured to calculate, based on the phase component signal, at each frequency, a phase gradient being a gradient of a phase component at a frequency;
a score calculation means configured to calculate a score relating to a sudden change characteristic of the input signal according to a plurality of phase gradients; and
a determination means configured to determine, based on the score, presence or absence of a sudden change in the determination target signal.

[Supplementary Note 2]

The signal processing device according to Supplementary Note 1, in which
the score calculation means calculates a value relating to an appearance frequency of the phase gradient in each of the determination target signal and the overlap signal, and calculates the score by integrating values relevant to a same time among the calculated values relating to the appearance frequency.

[Supplementary Note 3]

The signal processing device according to Supplementary Note 1, in which
the score calculation means calculates a value relating to an appearance frequency of the phase gradient in each of the determination target signal and the overlap signal, performs weighting according to the appearance frequency on the calculated value relating to the appearance frequency, and calculates the score by integrating values relevant to a same time among the weighted values relating to the appearance frequency.

[Supplementary Note 4]

The signal processing device according to any one of Supplementary Notes 1 to 3, in which
the determination means determines presence or absence of a sudden change in the determination target signal based on a maximum value of the score and a time at which the score becomes maximum.

[Supplementary Note 5]

The signal processing device according to any one of Supplementary Notes 1 to 3, in which
the determination means determines presence or absence of a sudden change in the determination target signal based on a value obtained by converting a maximum value in a probability density function fitted to the score according to a variance of the probability density function and a time at which a value of the probability density function becomes maximum.

[Supplementary Note 6]

The signal processing device according to any one of Supplementary Notes 1 to 5, in which
the cutout means cuts out a plurality of the overlap signals.

[Supplementary Note 7]

The signal processing device according to any one of Supplementary Notes 1 to 6, further including:
a reliability calculation means configured to calculate, when it is determined that there is a sudden change in the determination target signal, reliability indicating a possibility of being a frequency of a signal indicating the sudden change for each frequency of the determination target signal based on a phase gradient of each frequency of the determination target signal and an estimated value of a phase gradient of a signal indicating the sudden change calculated according to the score.

[Supplementary Note 8]

A signal processing method including:
cutting out, from an input signal, a determination target signal in a predetermined section, and an overlap signal in a section not matching the predetermined section but overlapping with at least a part of the predetermined section;
converting each of the determination target signal and the overlap signal into a phase component signal in a frequency domain with respect to each frequency;
calculating, based on the phase component signal, at each frequency, a phase gradient being a gradient of a phase component at a frequency;
calculating a score relating to a sudden change characteristic of the input signal according to a plurality of phase gradients; and
determining, based on the score, presence or absence of a sudden change in the determination target signal.

[Supplementary Note 9]

The signal processing method according to Supplementary Note 8, further including:
calculating a value relating to an appearance frequency of the phase gradient in each of the determination target signal and the overlap signal, and calculating the score by integrating values relevant to a same time among the calculated values relating to the appearance frequency.

[Supplementary Note 10]

The signal processing method according to Supplementary Note 8, further including:
calculating a value relating to an appearance frequency of the phase gradient in each of the determination target signal and the overlap signal, performing weighting according to the appearance frequency on the calculated value relating to the appearance frequency, and calculating the score by integrating values relevant to a same time among the weighted values relating to the appearance frequency.

[Supplementary Note 11]

The signal processing method according to any one of Supplementary Notes 8 to 10, further including:
determining presence or absence of a sudden change in the determination target signal based on a maximum value of the score and a time at which the score becomes maximum.

[Supplementary Note 12]

The signal processing method according to any one of Supplementary Notes 8 to 10, further including:
determining presence or absence of a sudden change in the determination target signal based on a value obtained by converting a maximum value in a probability density function fitted to the score according to a variance of the probability density function and a time at which a value of the probability density function becomes maximum.

[Supplementary Note 13]

The signal processing method according to any one of Supplementary Notes 8 to 12, further including:
cutting out a plurality of the overlap signals.

[Supplementary Note 14]

The signal processing method according to any one of Supplementary Notes 8 to 13, further including:
calculating, when it is determined that there is a sudden change in the determination target signal, reliability indicating a possibility of being a frequency of a signal indicating the sudden change for each frequency of the determination target signal based on a phase gradient of each frequency of the determination target signal and an estimated value of a phase gradient of a signal indicating the sudden change calculated according to the score.

[Supplementary Note 15]

A computer-readable storage medium storing a program causing a computer to execute:
cutting out, from an input signal, a determination target signal in a predetermined section, and an overlap signal in a section not matching the predetermined section but overlapping with at least a part of the predetermined section;
converting each of the determination target signal and the overlap signal into a phase component signal in a frequency domain with respect to each frequency;
calculating, based on the phase component signal, at each frequency, a phase gradient being a gradient of a phase component at a frequency;
calculating a score relating to a sudden change characteristic of the input signal according to a plurality of phase gradients; and
determining, based on the score, presence or absence of a sudden change in the determination target signal.

[Supplementary Note 16]

The computer-readable storage medium according to Supplementary Note 15, further including:
in the calculating a score, calculating a value relating to an appearance frequency of the phase gradient in each of the determination target signal and the overlap signal, and calculating the score by integrating values relevant to a same time among the calculated values relating to the appearance frequency.

[Supplementary Note 17]

The computer-readable storage medium according to Supplementary Note 15, further including:
in the calculating a score, calculating a value relating to an appearance frequency of the phase gradient in each of the determination target signal and the overlap signal, performing weighting according to the appearance frequency on the calculated value relating to the appearance frequency, and calculating the score by integrating values relevant to a same time among the weighted values relating to the appearance frequency.

[Supplementary Note 18]

The computer-readable storage medium according to any one of Supplementary Notes 15 to 17, further including:
determining, in the determining, presence or absence of a sudden change in the determination target signal based on a maximum value of the score and a time at which the score becomes maximum.

[Supplementary Note 19]

The computer-readable storage medium according to any one of Supplementary Notes 15 to 17, further including:
determining, in the determining, presence or absence of a sudden change in the determination target signal based on a value obtained by converting a maximum value in a probability density function fitted to the score according to the probability density function of the score and a time at which a value of the probability density function becomes maximum.

[Supplementary Note 20]

The computer-readable storage medium according to any one of Supplementary Notes 15 to 19, further including:
in the cutting out, cutting out a plurality of the overlap signals.

[Supplementary Note 21]

The computer-readable storage medium storing a program according to any one of Supplementary Notes 15 to 20, the program causing a computer to further execute:
calculating, when it is determined that there is a sudden change in the determination target signal, reliability indicating a possibility of being a frequency of a signal indicating the sudden change for each frequency of the determination target signal based on a phase gradient of each frequency of the determination target signal and an estimated value of a phase gradient of a signal indicating the sudden change calculated according to the score.

### REFERENCE SIGNS LIST

100, 101 signal processing device
110 cutout unit
120 conversion unit
130 gradient calculation unit
140 score calculation unit
150 determination unit
160 reliability calculation unit

What is claimed is:

1. A signal processing device comprising:
a memory; and
at least one processor coupled to the memory
the at least one processor performing operations to:
cut out, from an input signal, a determination target signal in a predetermined section and an overlap signal in a section not matching the predetermined section but overlapping with at least a part of the predetermined section;
convert each of the determination target signal and the overlap signal into a phase component signal in a frequency domain with respect to each frequency;
calculate, based on the phase component signal, at each frequency, a phase gradient being a gradient of a phase component at a frequency;
calculate a score relating to a sudden change characteristic of the input signal according to a plurality of phase gradients; and
determine, based on the score, presence or absence of a sudden change in the determination target signal.

2. The signal processing device according to claim 1, wherein the at least one processor further performs operation to:
calculate a value relating to an appearance frequency of the phase gradient in each of the determination target signal and the overlap signal, and calculate the score by integrating values relevant to a same time among the calculated values relating to the appearance frequency.

3. The signal processing device according to claim 1, wherein the at least one processor further performs operation to:
calculate a value relating to an appearance frequency of the phase gradient in each of the determination target signal and the overlap signal, performs weighting according to the appearance frequency on the calculated value relating to the appearance frequency, and calculate the score by integrating values relevant to a same time among the weighted values relating to the appearance frequency.

4. The signal processing device according to claim 1, wherein the at least one processor further performs operation to:
determine presence or absence of a sudden change in the determination target signal based on a maximum value of the score and a time at which the score becomes maximum.

5. The signal processing device according to claim 1, wherein the at least one processor further performs operation to:
determine presence or absence of a sudden change in the determination target signal based on a value obtained by converting a maximum value in a probability density function fitted to the score according to a variance of the probability density function and a time at which a value of the probability density function becomes maximum.

6. The signal processing device according to claim 1, wherein the at least one processor further performs operation to:
cut out a plurality of the overlap signals.

7. The signal processing device according to claim 1, wherein the at least one processor further performs operation to:
calculate, when it is determined that there is a sudden change in the determination target signal, reliability indicating a possibility of being a frequency of a signal indicating the sudden change for each frequency of the determination target signal based on a phase gradient of each frequency of the determination target signal and an estimated value of a phase gradient of a signal indicating the sudden change calculated according to the score.

8. A signal processing method comprising:
cutting out, from an input signal, a determination target signal in a predetermined section, and an overlap signal in a section not matching the predetermined section but overlapping with at least a part of the predetermined section;
converting each of the determination target signal and the overlap signal into a phase component signal in a frequency domain with respect to each frequency;
calculating, based on the phase component signal, at each frequency, a phase gradient being a gradient of a phase component at a frequency;
calculating a score relating to a sudden change characteristic of the input signal according to a plurality of phase gradients; and
determining, based on the score, presence or absence of a sudden change in the determination target signal.

9. The signal processing method according to claim 8, further comprising:
calculating a value relating to an appearance frequency of the phase gradient in each of the determination target signal and the overlap signal, and calculating the score by integrating values relevant to a same time among the calculated values relating to the appearance frequency.

10. The signal processing method according to claim 8, further comprising:
calculating a value relating to an appearance frequency of the phase gradient in each of the determination target signal and the overlap signal, performing weighting according to the appearance frequency on the calculated value relating to the appearance frequency, and calculating the score by integrating values relevant to a same time among the weighted values relating to the appearance frequency.

11. The signal processing method according to claim 8, further comprising:
determining presence or absence of a sudden change in the determination target signal based on a maximum value of the score and a time at which the score becomes maximum.

12. The signal processing method according to claim 8, further comprising:
determining presence or absence of a sudden change in the determination target signal based on a value obtained by converting a maximum value in a probability density function fitted to the score according to a variance of the probability density function and a time at which a value of the probability density function becomes maximum.

13. The signal processing method according to claim 8, further comprising:
cutting out a plurality of the overlap signals.

14. The signal processing method according to claim 8, further comprising:
calculating, when it is determined that there is a sudden change in the determination target signal, reliability indicating a possibility of being a frequency of a signal indicating the sudden change for each frequency of the determination target signal based on a phase gradient of each frequency of the determination target signal and an estimated value of a phase gradient of a signal indicating the sudden change calculated according to the score.

15. A non-transitory computer-readable storage medium storing a program causing a computer to execute:
cutting out, from an input signal, a determination target signal in a predetermined section, and an overlap signal in a section not matching the predetermined section but overlapping with at least a part of the predetermined section;
converting each of the determination target signal and the overlap signal into a phase component signal in a frequency domain with respect to each frequency;
calculating, based on the phase component signal, at each frequency, a phase gradient being a gradient of a phase component at a frequency;
calculating a score relating to a sudden change characteristic of the input signal according to a plurality of phase gradients; and
determining, based on the score, presence or absence of a sudden change in the determination target signal.

16. The non-transitory computer-readable storage medium according to claim 15, further comprising:
in the calculating a score, calculating a value relating to an appearance frequency of the phase gradient in each of the determination target signal and the overlap signal, and calculating the score by integrating values relevant to a same time among the calculated values relating to the appearance frequency.

17. The non-transitory computer-readable storage medium according to claim 15, further comprising:
in the calculating a score, calculating a value relating to an appearance frequency of the phase gradient in each of the determination target signal and the overlap signal, performing weighting according to the appearance frequency on the calculated value relating to the appearance frequency, and calculating the score by integrating values relevant to a same time among the weighted values relating to the appearance frequency.

18. The non-transitory computer-readable storage medium according to claim 15, further comprising:
determining, in the determining, presence or absence of a sudden change in the determination target signal based on a maximum value of the score and a time at which the score becomes maximum.

19. The non-transitory computer-readable storage medium according to claim 15, further comprising:
determining, in the determining, presence or absence of a sudden change in the determination target signal based on a value obtained by converting a maximum value in a probability density function fitted to the score according to the probability density function of the score and a time at which a value of the probability density function becomes maximum.

20. The non-transitory computer-readable storage medium according to claim 15, further comprising:
in the cutting out, cutting out a plurality of the overlap signals.

21. (canceled)
